(19) United States
(12) Patent Application Publication
(10) Pub. No.: US 2026/0154734 A1
(43) Pub. Date: Jun. 4, 2026

(54) TEMPLATE AUTOMATION AND MANAGEMENT

(71) Applicant: Bank of America Corporation, Charlotte, NC (US)

(72) Inventors: Hannah Furr, Charlotte, NC (US); Amy M. McNeil, Charlotte, NC (US); Quentin Petty, Charlotte, NC (US); Reginald R. Hayes, Charlotte, NC (US); Richard E. Dillahunt, Charlotte, NC (US)

(21) Appl. No.: 18/966,887

(22) Filed: Dec. 3, 2024

(51) Int. Cl. G06Q 40/02

(52) U.S. Cl. CPC G06Q 40/02

(57) ABSTRACT

A management platform may provide client templates for clients to perform financial transactions using data populated in the client templates. First data in a first client template for a first client may change. The template automation artificial intelligence (AI) engine may update the first data to second data where the first data is from a third party and the AI engine detects a change in the third-party data. The AI engine may automatically update the first data to the second data in other client templates for other clients, where the first data is included in the one or more of the other client templates. The management platform may provide multiple payee templates used by a payee to track payments from payors. The AI engine may merge the payee templates into a combined payee template, which may optimize client interaction or efficiency.

### FIELD OF THE DISCLOSURE

Aspects of the disclosure relate to leveraging artificial intelligence (AI) to automate management and modification of client and payee templates for interacting with a financial management platform.

### BACKGROUND OF THE DISCLOSURE

A management platform operated by a financial services company, such as a bank, may be used by clients for the clients to make payments or by payees/payment recipients to manage the payees, or may be used for both purposes. Separate templates may be provided for the clients to manage their banking. These templates may be customizable by a client or payee or by the financial services company and may include, for example, different fields with different types of information displayed, and different display formats. Clients and payees may also have multiple accounts and may use different templates for different accounts.

Data obtained from third-party sources, such as payee information used by clients for electronic payment, may change from time to time. Each client must manually update their client template(s) that are populated with the third-party information to reflect changes in the information.

Payees may maintain payee templates to track monies owed or paid by payors. Payees may each have multiple payee templates which may complicate the tracking of information included in the payee templates.

It may be desirable to enable automation of template management to enable automated updates of templates to include updates to third-party information populated in the templates.

It may be desirable to streamline the number of payee templates that are maintained by a particular payee.

### SUMMARY OF THE DISCLOSURE

It is an object of this invention to provide a system and method to use an automated client template module of an AI engine to automate updates of information in templates that clients use for interacting with the financial institution when information in the templates is derived from a third party and a change in the third party information is detected for one of the templates.

It is an object of this invention to provide a system and method to use a payee template module of an AI engine to automate a modification of payee templates to merge multiple payee templates to streamline the number of templates, better organize the payee templates, and make them more efficient.

A system and method in accordance with the present disclosure may be implemented. The system may include a processor and a management platform. The management platform may include a management application module that is configured for clients to manage finances. The management platform may include one or more client templates for interacting with the management application module. The management platform may include a database that includes one or more client-specific templates that are each populated with client-specific data for a different one of the clients. The one or more client-specific templates may include one or more fields populated with third-party data obtained from one or more third parties.

The management application module may be configured to detect an update to the third-party data that is populated in a first field of the one or more fields of a first client-specific template such that first data in the first field has been changed to second data. The processor may detect the update using a template automation artificial intelligence (AI) engine operatively connected to the management application module. The update to the third-party data may have been made internally or externally to the management platform.

The management application module may be configured to determine, by the processor using the template automation AI engine, whether one or more of the one or more client-specific templates other than the first client-specific template includes the first data. The management application module may be configured to automatically update, by the processor, the one or more client-specific templates that includes the first data to change the first data to the second data.

The one or more client-specific templates may be customizable by the clients or by an entity that owns or manages the management platform. The one or more client-specific templates may be populated based on client-provided information and the third-party data.

The first data and the second data may each include one or more codes. The update of the first data to the second data may include a code change. The one or more codes may include one or more of an American Bankers Association (ABA) routing number, a business identifier code (BIC), or a tax-related code. The first data and the second data may include contact information for an organization or a payment recipient and the update of the first data may include a change in the contact information.

The processor may be configured to use the template automation AI engine to initiate the detection of the update to the third-party data from the first data to the second data upon the client arranging for an electronic payment to be made.

The processor may be configured to use the template automation AI engine to recognize a client failure to pay an amount due to a recipient due to the change in the third-party data populated in a first of the one or more client-specific templates and to automatically update the first data to the second data in the first of the client-specific templates to enable a successful payment of the amount due.

The processor may be configured to prompt the client to confirm that the automated change of the first data to the second data in the one or more of the client-specific templates that include the first data should proceed before the automated change is performed.

The management application module may include a banking application for conducting banking.

The database may include recipient-specific templates configured for use by a recipient to track payments by one or more payors to the recipients. The recipient may be an account holder at a financial institution to whom payments are transferred.

The template automation AI engine may include a recipient template module. The recipient template module may be configured for the processor to take an automated inventory of the recipient-specific templates for the recipient in the database. The recipient template module may analyze the inventoried plurality of recipient-specific templates for template configurations. The configurations of the templates may include the organization of the templates. The configurations of the templates may include the contents of the templates.

The recipient template module may automatically merge multiple recipient-specific templates for the recipient into a combined recipient-specific template that is populated with payor data from the recipient-specific templates and is organized for presentation to the recipient based on organization and contents of the recipient-specific templates. Each of the recipient-specific templates for the recipient may include payment data for payments received by the recipient per recipient account.

Each of the recipient-specific templates may be customized for use by the recipient. Usage of each of the recipient-specific templates may be monitored and analyzed by the template automation AI engine. The combined recipient-specific template may be configured based on the recipient-specific templates for the recipient.

The combined recipient-specific template may be configured based on one of the recipient-specific templates or portions thereof that are most used by the recipient at a time at which the combined recipient-specific template for the specific recipient is generated. The combined recipient-specific template may be configured to be based on one of the recipient-specific templates that the template automation AI engine determines is efficient for the recipient to review at a time of the merging of the recipient-specific templates of the payee.

A system and method in accordance with the present disclosure may be implemented. The system may include a processor and a management platform for interacting with account holders at a financial institution to whom payments are transferred or owed by one or more parties. The management platform may include a database that includes recipient-specific templates that are configured for use by the recipients to track payments by the one or more parties to the recipients. The management platform may include a template automation AI engine that includes a payee template module. The template automation AI engine may be configured for a processor to take an automated inventory of the recipient-specific templates for a specific one of the recipients. The template automation AI engine may be configured for the processor to analyze template configurations of multiple recipient-specific templates for the specific recipient. The template automation AI engine may be configured for the processor to automatically merge the plurality of the recipient-specific templates for the specific recipient into a combined recipient-specific template. The combined recipient-specific template may be populated with data from the recipient-specific templates and may be organized for presentation to the specific recipient.

The combined recipient-specific template may include payment data for payments received by the specific recipient by recipient account.

Each of the recipient-specific templates for the specific recipient may be customized for use by the recipient. Usage of each of the recipient-specific templates for the specific recipient may be monitored and analyzed by the template automation AI engine. The combined recipient-specific template may be configured based on the recipient-specific templates for the specific recipient.

The combined recipient-specific template may be configured to be based on one or more of the recipient-specific templates that the template automation AI engine determines the template automation AI engine is most efficient for the specific recipient at a time of the merging of the recipient-specific templates of the specific recipient to analyze payments.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system architecture in accordance with principles of the disclosure.

FIG. 2 shows an illustrative apparatus of a device in accordance with principles of the disclosure.

FIG. 3 shows an illustrative system architecture in accordance with principles of the disclosure.

FIG. 4A shows an illustrative first client template in accordance with principles of the disclosure.

FIG. 4B shows an illustrative second client template in accordance with principles of the disclosure.

FIG. 4C shows an illustrative updated first client template in accordance with principles of the disclosure.

FIG. 4D shows an illustrative updated second client template in accordance with principles of the disclosure.

FIG. 5A shows an illustrative first payee template in accordance with principles of the disclosure.

FIG. 5B shows an illustrative second payee template in accordance with principles of the disclosure.

FIG. 5C shows an illustrative combined payee banking template based on the first and second payee templates in accordance with principles of the disclosure.

FIG. 6 shows an illustrative flow chart for automated template management in accordance with principles of the disclosure.

FIG. 7 shows an illustrative flow chart for automated template management in accordance with principles of the disclosure.

FIG. 8 shows an illustrative system architecture for template automation and management in accordance with principles of the disclosure.

### DETAILED DESCRIPTION OF THE DISCLOSURE

A system and method may be provided for automatically managing templates that are used by clients to interact with a financial institution. The system may include a financial management platform, such as a banking platform. The templates that are managed may be populated with data that may change and may be automatically updated to reflect a change in data, organization, or contents that are populated in the template. The templates may be customized by a client. The templates may be customized by the financial institution for the client. The customization may include the type or content of fields that are included within the templates. The templates may be client-specific templates populated with client-specific data. The templates may be templates for recipients of payments from one or more parties to track payments that are transferred or are owed by one or more of the parties. The recipient may be an account holder at a financial institution. A recipient may be a payee and the parties that owe or transfer money to the recipient may be a payor. The recipient templates may be customized by or for the payees to be payee-specific.

One or more client-specific templates may include information that is obtained from one or more third parties. From time to time, the information from the one or more third parties may change. Changes to the third-party information may be made externally to the financial management platform and monitored by a template automation AI engine that detects a change and may capture it internally at the financial management platform.

The changes may be detected at various times. For example, a change may be detected when the client uses the template for the first time after the third-party information is changed. As another example, the change may be detected when the client arranges for an electronic payment to be made and may confirm that the payee information is up-to-date. As another example, the change may be detected when the template automation AI engine recognizes a client failure to pay an amount due to a payee which may result when the third-party data is out of date.

The template automation AI engine may include a client template module that may update the first information that is included in the first client template. Upon determining that the first information has changed, the template automation AI engine may also identify other client-specific templates used with the system that include the same information that has changed, and may update that same information that has been updated in the first client-specific template.

Examples of third-party information that may change and need to be updated in client templates include changes in codes, such as changes in an American Bankers Association (ABA) routing number, a bank identifier code (BIC), or a tax-related code. An ABA routing number is a nine-digit code that identifies the financial institution responsible for the payment of a negotiable instrument. A BIC code is an 8-11 digit code that identifies a bank or financial institution globally. The BIC code may include a multi-part code including a 4-letter bank code, followed by a 2-letter country code for the country where the bank is located, a 2-letter location code identifying the location of the bank's main offer, and may include a 3-digit branch code specifying a branch of the bank. The ABA routing number may change, such as due to a bank sale or merger. The BIC number may change due to a sale or merger or a change in location of the main office or branch. Another example of information that may change is a change to payee contact information, such as an address, email, or phone number.

Additionally, a payee may have multiple payee accounts with a financial institution. These accounts may be associated with different payee templates. The different payee templates may not be identical to one another so that different payee templates may include for display different information related to the payor account. This may make it inefficient for a payee to review or track payments received from payors.

A system and method may be provided to identify and inventory payee templates of the same payee and automate generation of a single payee template that includes information related to payor payments, including, for example, payee accounts and transactions. The system and method may use an automated template AI engine that implements machine learning (ML) to examine a database of payee templates and the multiple payee templates for this payee to determine an efficient payee templates that includes relevant information in the single template. The efficiency of the payee templates may be determined based on the intended recipient(s) of the payee templates and based on an efficiency at a time of the merging of the templates to analyze payments.

It may be determined that all of the payee templates for this payee may be automatically merged. For example, multiple templates for the same payee or the payee templates may be compared by the AI engine to determine an optimized single payee template for this payee. Optimized payee templates may be optimized in different ways. For example, payee templates may be based on templates that are most used by the payee. The merger of the payee templates may account for efficiencies, such as efficiency for the payee to review. Efficiencies may be achieved such as, for example, by prioritizing the display of fields that are most populated with data for each payor or for payors, or grouping entries from different recipient templates by payor. The optimized payee template may include some or all of the fields in the existing payee templates for this payee, and may be modified by the AI engine to include additional fields for one or more transactions.

Illustrative embodiments of methods, systems, and apparatus in accordance with the principles of the invention will now be described with reference to the accompanying drawings, which form a part hereof. It is to be understood that other embodiments may be used, and structural, functional, and procedural modifications may be made without departing from the scope and spirit of the present invention.

The drawings show illustrative features of methods, systems, and apparatus in accordance with the principles of the invention. The features are illustrated in the context of selected embodiments. It will be understood that features shown in connection with one of the embodiments may be practiced in accordance with the principles of the invention along with features shown in connection with another of the embodiments.

The methods, apparatus, computer program products, and systems described herein are illustrative and may involve some or all the steps of the illustrative methods and/or some or all of the features of the illustrative system or apparatus. The steps of the methods may be performed in an order other than the order shown or described herein. Some embodiments may omit steps shown or described in connection with the illustrative methods. Some embodiments may include steps that are not shown or described in connection with the illustrative methods, but rather are shown or described in a different portion of the specification.

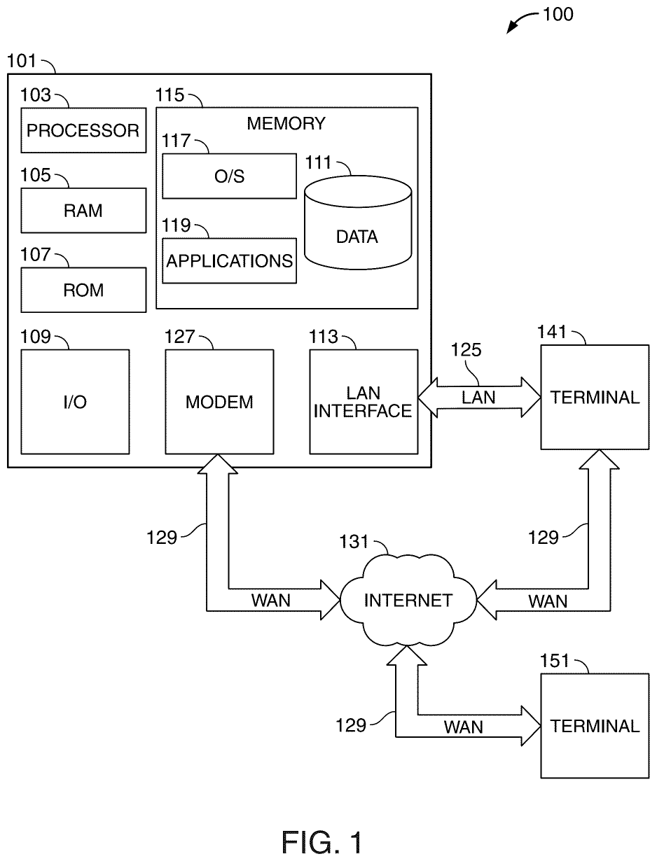

FIG. 1 shows an illustrative block diagram of system 100 that includes computer 101. Computer 101 may alternatively be referred to herein as an “engine,” “server” or a “computing device.” Computer 101 may be any computing device described herein, such as the computing devices running on a computer, smart phones, smart cars, smart cards, and any other mobile device described herein. Elements of system 100, including computer 101, may be used to implement various aspects of the systems and methods disclosed herein.

Computer 101 may have a processor 103 for controlling the operation of the device and its associated components, and may include RAM 105, ROM 107, input/output circuit 109, and a non-transitory or non-volatile memory 115. Machine-readable memory may be configured to store information in machine-readable data structures. Other components commonly used for computers, such as EEPROM or Flash memory or any other suitable components, may also be part of the computer 101.

Memory 115 may be comprised of any suitable permanent storage technology-e.g., a hard drive. Memory 115 may store software including the operating system 117 and application(s) 119 along with any data 111 needed for the operation of computer 101. Memory 115 may also store videos, text, and/or audio assistance files. The data stored in Memory 115 may also be stored in cache memory, or any other suitable memory.

Input/output (“I/O”) module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

Computer 101 may be connected to other systems via a local area network (LAN) interface 113. Computer 101 may operate in a networked environment supporting connections to one or more remote computers, such as terminals 141 and 151. Terminals 141 and 151 may be personal computers or servers that include many or all the elements described above relative to computer 101.

In some embodiments, computer 101 and/or Terminals 141 and 151 may be any of mobile devices that may be in electronic communication with consumer device 106 via LAN, WAN, or any other suitable short-range communication when a network connection may not be established.

When used in a LAN networking environment, computer 101 is connected to LAN 125 through a LAN interface 113 or an adapter. When used in a WAN networking environment, computer 101 may include a communications device, such as modem 127 or other means, for establishing communications over WAN 129, such as Internet 131.

In some embodiments, computer 101 may be connected to one or more other systems via a short-range communication network (not shown). In these embodiments, computer 101 may communicate with one or more other terminals 141 and 151, such as the mobile devices described herein etc., using a personal area network (PAN) such as Bluetooth®, NFC (Near Field Communication), ZigBee, or any other suitable personal area network.

It will be appreciated that the network connections shown are illustrative and other means of establishing a communications link between computers may be used. The existence of various well-known protocols such as TCP/IP, Ethernet, NFT, HTTP, and the like is presumed, and the system can be operated in a client-server configuration to permit retrieval of data from a web-based server or API (Application Programming Interface). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application programs 119 may use one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may use the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 119 may include one or more algorithms that may be used to implement features of the disclosure.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry™, tablet, smartphone, or any other computing system for receiving, storing, transmitting and/or displaying relevant information. Terminal 151 and/or terminal 141 may be one or more user devices. Terminals 151 and 141 may be identical to computer 101 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smartphones, multiprocessor systems, microprocessor-based systems, cloud-based systems, programmable consumer electronics, network PCs, minicomputers, mainframe computers, distributed computing environments that include any of the above systems or devices, and the like.

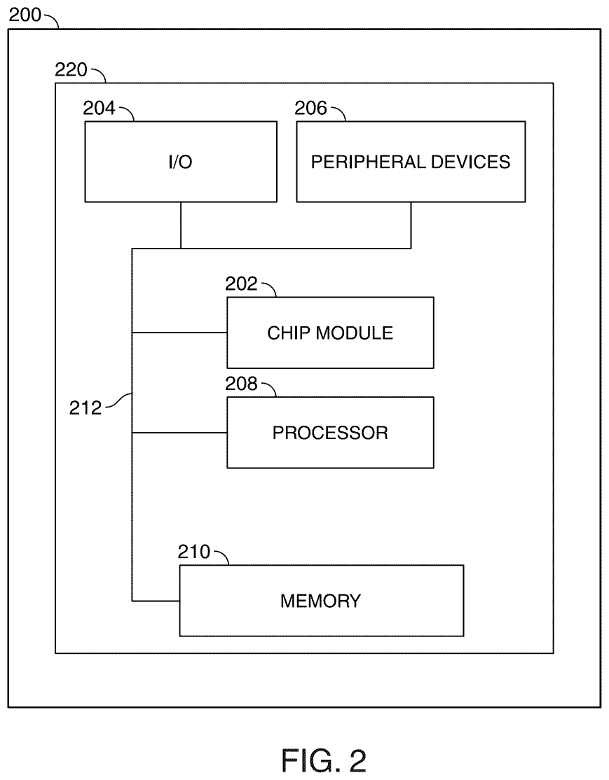

FIG. 2 shows illustrative apparatus 200, which may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY level hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

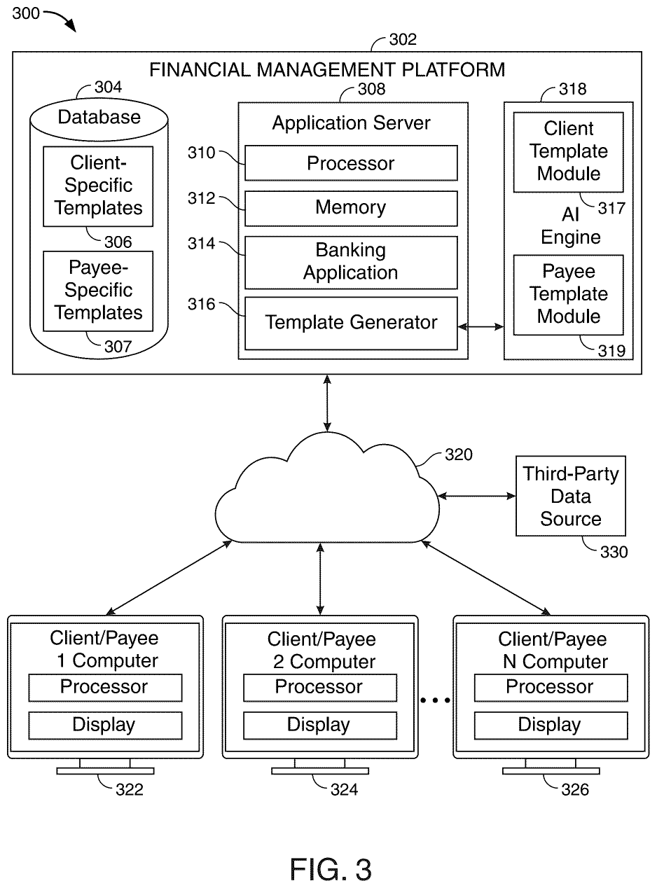

FIG. 3 shows an illustrative system architecture which may be used to provide a system 300 for template automation and management that may be implemented in accordance with principles of the disclosure. System 300 may include a financial management platform 302, which may be a banking platform used for clients. System 300 may include respective client or payee computers 1 . . . N, including computers 322, 324, and 326, that a client or payee may use to interact with financial management platform 302 via a network 320, such as the Internet. System 300 may also include a third-party data source 330.

Financial management platform 302 may include a server 308 that may include a processor 310, a memory 312, a banking application 314, and a template generator 316 for generating and updating client and payee templates. Financial management platform 302 may include database 304 in which client templates 306 that may be client-specific templates and in payee templates 307 that may be payee-specific may be stored. Client and payee templates may also be stored in memory 312. Financial management platform 302 may further include a template automation AI engine 318 that may include a client template module 319 and a payee template module 321. Client template module 319 may be configured to automate changes to client templates using template automation AI engine 318 to update fields in the templates across multiple client templates. The updates may be made by overwriting first data in a field with second data, which may be an updated value or updated information. Payee template module 321 may be configured to automate changes to the payee templates using AI, such as to inventory payee-specific templates and merge multiple payee-specific templates for a payee or add, remove, or rearrange columns in the payee templates. Client templates and payee templates may each be organized in a tabular format, or in some other format.

Template automation AI engine 318 may communicate with one or more third-party sources 330, which may be servers, networks, data stores, other hardware or software, or a combination thereof, that may maintain data such as current ABA routing numbers, BIC codes, tax-related codes, payee contact information, or other information that may be used in the client or payee templates. Data in the data sources may be updated from time to time. Multiple client templates and payee templates may be updated when a change in information, such as a code or contact information, is detected. Template automation AI engine 318 may communicate with other components of financial management platform 302.

Client or payee computers 322, 324, 326 may each have a respective processor and a display and other hardware or software to interact with financial management platform 302 using banking application 314 and associated client or payee templates.

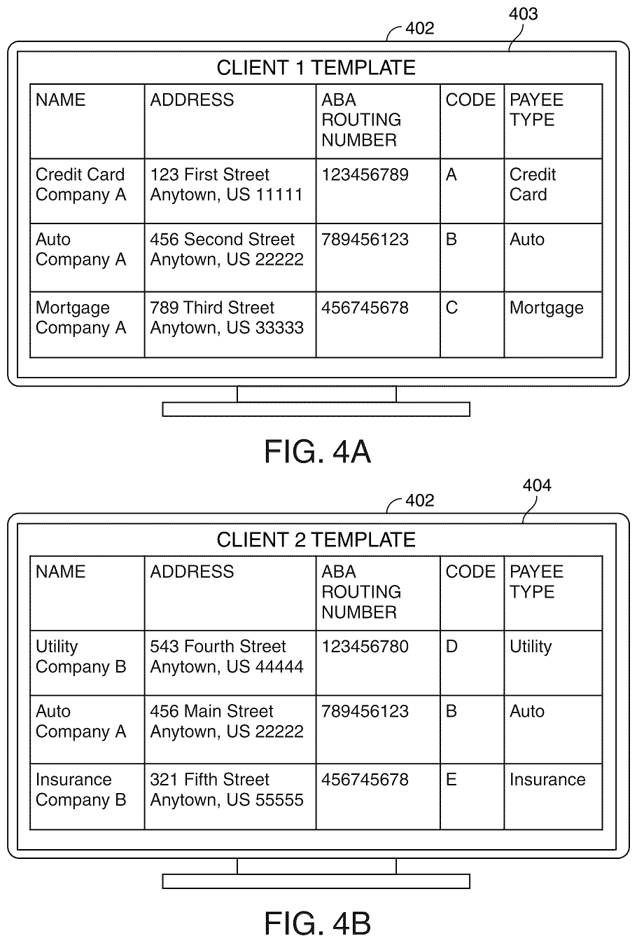

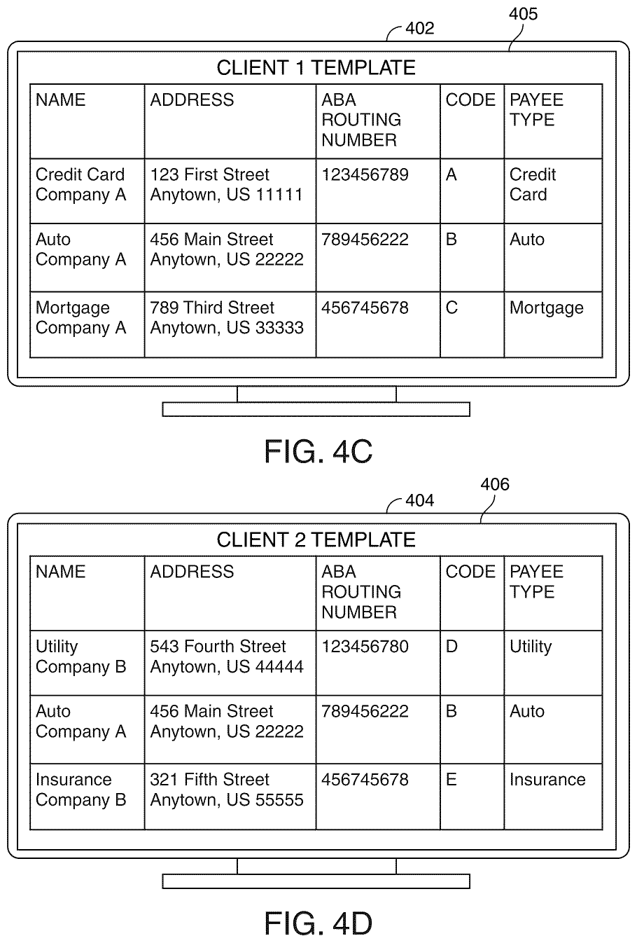

FIG. 4A shows an illustrative example of a screen 402 displaying a first client template 403 for a first client 1. Template 403 may be client-specific to include client-specific information. Template 403 may include a first column for names of payees, a second column with addresses of the payees, a third column with the ABA routing numbers and account numbers of payees where applicable, a fourth column with a code, such as an 8-11 character BIC code, and a payee type. Information for multiple payees may be shown using template 402. In the illustrated example, entries in template 403 may include entries for three payees Credit Card Company A, Auto Company A, and Mortgage Company A and related information for each payee is listed.

FIG. 4B shows an illustrative example of a second client template 404 that may be displayed on screen 402 and provided for a different second client 2. Template 404 may have the same or similar organization as template 403 or may be different from template 403. Template 404 may have a listing of payees for client 2 and may include the same type of information as template 403 for each payee as shown, or template 404 may include different types of information, or include the same type of information in a different order or layout than is used in template 403. Template 404 may be customizable by the client or customized for the client by the financial institution. As with client 1 template 403, template 404 may also include an entry for Auto Company A. Template automation AI engine 318 may scan other client templates in database 304 and detect that Auto Company A in template 403 is listed as having a different address, such as the address in template 404. Template automation AI engine 318 may be configured to check additional templates for consistency of entries including the entries for Auto Company A. Template automation AI engine 318 may be further configured to check other resources, such as online websites or subscription services, for the correct current address for Auto Company A and globally change all of the client templates in database 304 to be consistent and correct. Template automation AI engine 318 may also suggest the change and ask a client to confirm the change before it is implemented.

FIG. 4C shows an illustrative example of a revised table using first client template 402 for client 1. In this example, the address for Auto company A has been updated. Template automation AI engine 318 may determine, such as with reference to one or more online databases, client templates, or based on a change entered by a client, that Auto Company A uses a new ABA routing number (e.g., new number is 789456222 replacing previous number 789456123). Template automation AI engine 318 may update template 402 and may update other client templates, such as updated template 406 in FIG. 4D to include the new information as shown.

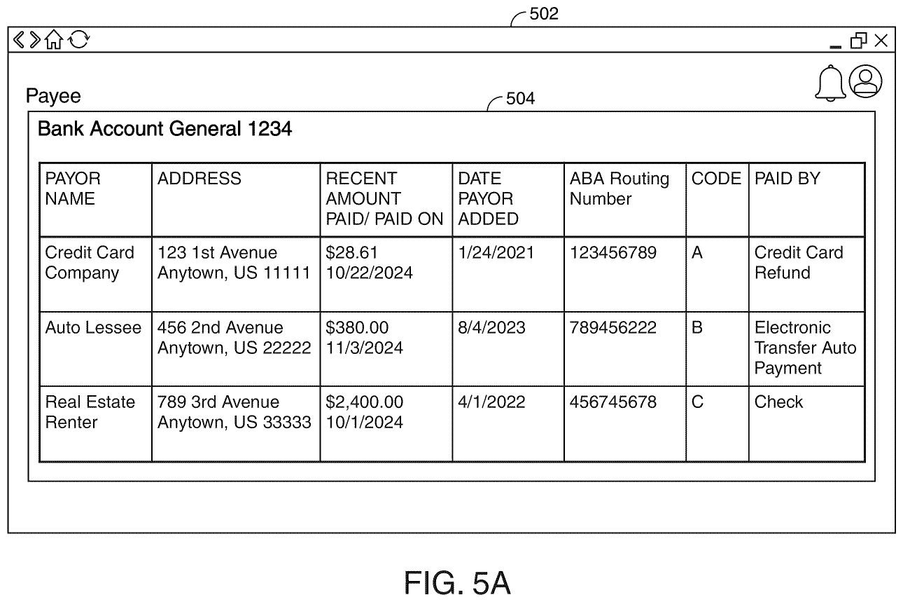

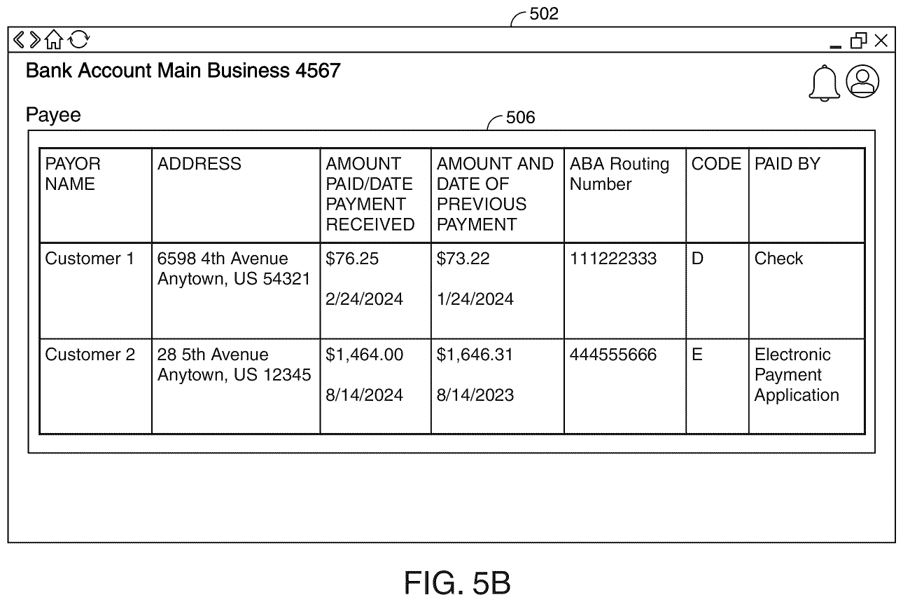

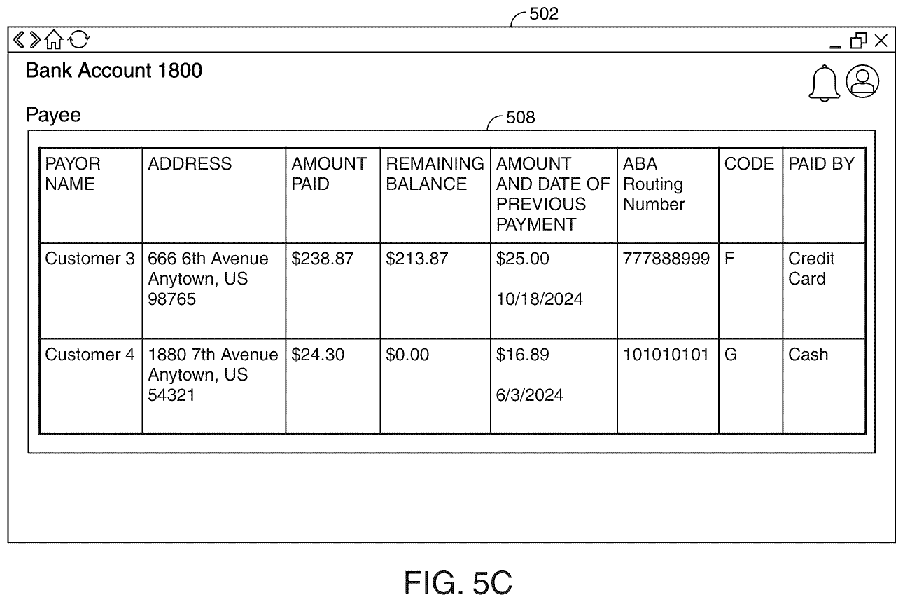

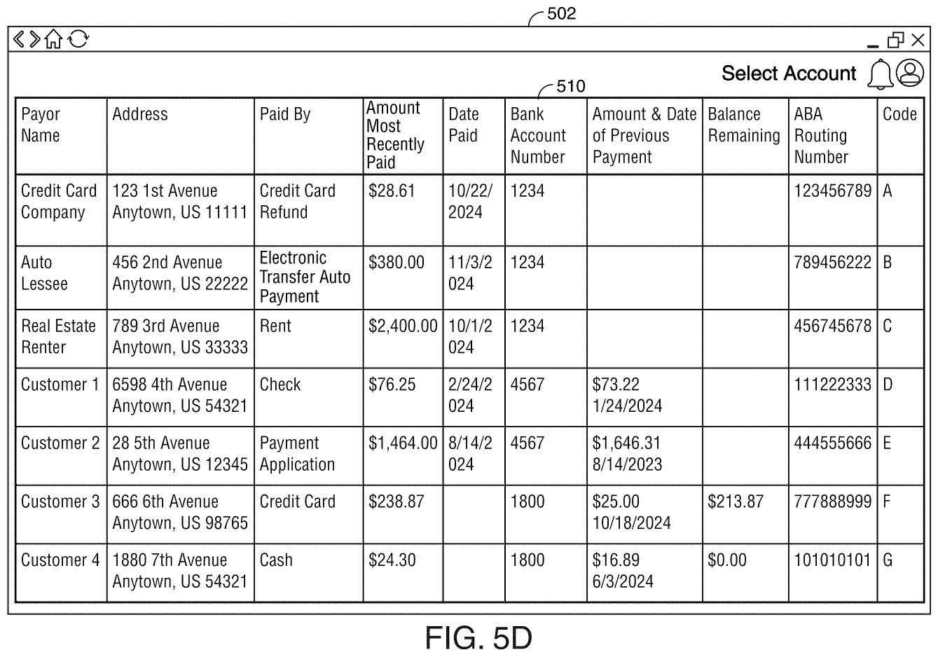

In addition to updating information stored in client templates, template automation AI engine 318 may be configured to update payee templates in which a payee may include information about its payors, and may include amounts payable or paid by the payors. Payee templates 307 may be stored in database 304. A single payee may have multiple payee templates, each of which may include information for different payors, or there may be overlap in the payees across the multiple payee templates. Illustrative examples of payee templates are shown in FIGS. 5A, 5B, and 5C.

FIG. 5A shows a first illustrative payee-specific template 504 for a payee. Template 504 may be displayed on a screen 502. In the illustrative payee template 502, payor information, such as payor names and addresses, may be listed in a tabular format or some other format. Columns may be included to list for one or more of the payors, for example, one or more of a recent amount paid and a date on which the amount was paid or an amount was credited, a date that the payor was added, an ABA routing number and a client bank account number (not shown) that was used for payment, if applicable, another type of code, such as a BIC code or a taxpayer code, and a method of payment, such as payment by credit card, an electronic transfer, which may have been manually arranged or by autopay, or a payment by check.

FIG. 5B shows a second illustrative payee-specific template 506 for the same payee but for a different payee bank account. Template 506 may differ from template 504. Template 506 may be displayed on screen 502. In this template, payor names and addresses may be included. One or more other columns may show an amount paid or refunded, a date of payment or refund, an amount and date of a previous payment, an ABA routing number and a payee account code, if applicable, a code, such as a BIC code or tax payment code, and a method of payment, such as a check or an electronic payment application.

FIG. 5C shows a third illustrative payee template 508. Template 508 may be displayed on screen 502. In this template, in addition to payor names and addresses, one or more other columns may show an amount paid or refunded, a remaining balance, an ABA routing number, a code, and a “paid by” field that may indicate a method of payment (e.g., credit card, cash, or some other manner).

Template automation AI engine 318 may be configured to use machine learning to generate a single combined payee template based on other payee templates for that payee, such as on payee templates shown in FIGS. 5A, 5B and 5C. The single combined payee template may be suggested to the payee for adoption by the payee or for modifications. For example, each added column in the single combined payee template may display a box which a payee may click on or avoid clicking on to indicate whether or not it wishes to add a particular column to the single combine payee template for a specific payee.

Template automation AI engine 318 may be configured to include all fields from existing templates for a specific payee in a merged template and may populate these fields with data from existing populated templates. These fields may include an ABA routing number, a payee account code, if applicable, a code, such as a BIC code or tax payment code, or a method of payment, such as a check or an electronic payment application. Template automation AI engine 318 may also look to other payee templates for other payees to determine whether additional information should be included in the single payee template for the payee, such as by adding a field.

FIG. 5D shows an illustrative combined payee template 510 based on templates 504, 506, and 508. Payee template 510 may include columns for payor name, address, “paid by” (method of payment), amount most recently paid, date most recently paid, bank account number, amount and date of previous payment, balance remaining, ABA routing number, and a code such as a BIC code or a tax code. All of the payors mays be listed on the same template for easier review and interaction by the payee. Not all information may be available or pertinent for each of the payors, in which case, certain fields for a payor may be left blank.

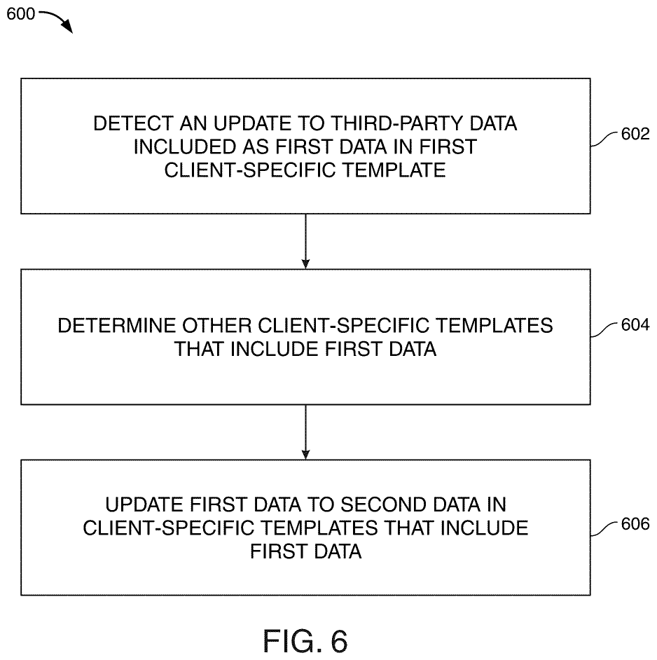

FIG. 6 shows illustrative flow chart 600 for automated template management in accordance with principles of the disclosure. In this flow chart, established client-specific templates may have already been generated by or for a client. The client-specific templates may have been generated based on a template provided by the financial institution that has been customized by the client. The client-specific templates may have been generated by an AI engine based on information obtained about the client or the client's requirements. Client data may also have been populated into fields in the template.

At step 602, a template automation AI engine may detect in a data source that includes third-party data that there is an update to third-party data that is included in a client-specific template. The detection may be accomplished by monitoring third-party data sources, bases, such as online databases. The update may update first data to second data.

At step 604, the AI engine may determine that other client-specific templates also include the first data, which is now out-of-date.

At step 606, the processor may automatically update the first data to second data in the client-specific templates for all clients that include this first data in their templates. For example, where the first data is a code or address that is outdated or incorrect, the first data may be updated or corrected.

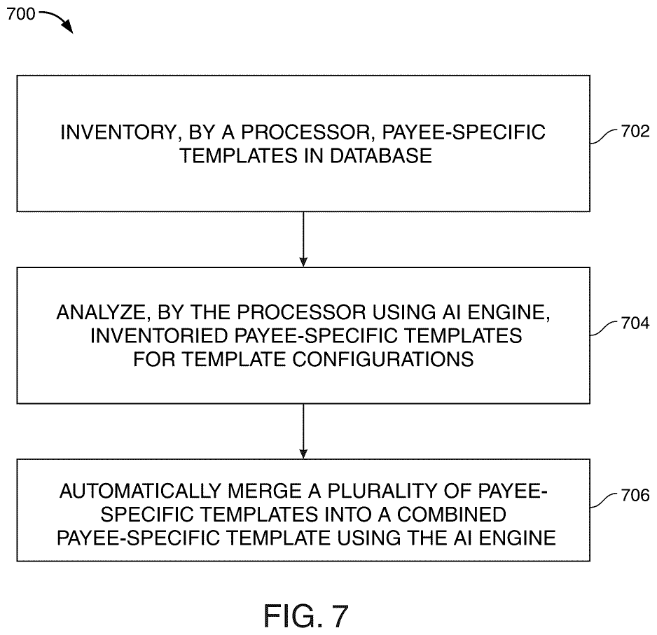

FIG. 7 shows another illustrative flow chart for automated template management where the templates are payee-specific templates. These payee-specific templates may have been generated by a payee. The payee may be the client in this instance, but the payee may have multiple payee templates in which payments by payors are tracked. There may be multiple templates for a single payee for different reasons, such as because the payee has multiple accounts at the bank and has a payee template for each account. The payee-specific templates may have been generated based on a template provided by the bank that has been customized by the payee. The payee-specific templates may have been generated by AI based on information obtained about the payee or the payee's requirements. Payor data may also have been populated into fields in the template.

At step 702, payee-specific templates may be inventoried to determine all templates at the bank that are associated with the payee. At step 704, the inventoried payee-specific templates may be analyzed by the AI engine to determine template configurations of the payee-specific templates. The configuration may include, for example, the organization of the template, or the content included in the template. The different payee-specific templates may have the same or different fields. At step 706, a plurality of payee-specific templates may be merged into a combined payee-specific template using the AI engine to determine how to formulate the combined payee-specific template, including what information to include. The AI engine may be configured to output a combined payee-specific template that is optimized based on the payee's past usage of the multiple payee-specific templates and efficiency for the payee in reviewing the information. The payee may choose to further modify the combined payee-specific template generated by the AI engine to further refine the combined payee-specific template.

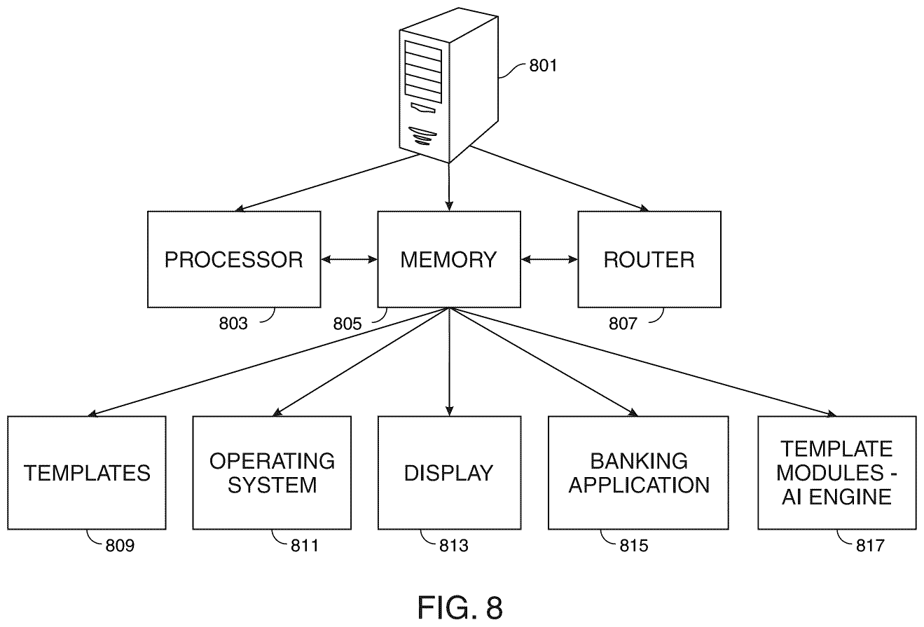

FIG. 8 shows an illustrative system architecture for template automation and management in accordance with principles of the disclosure. The system architecture may be implemented on a cloud or on the Internet. A server 801 may include a processor 803, a memory 805, and a router 807. Memory 805 may include an operating system 811, a display 813, a banking application 815 that may use client-specific templates or payee-specific templates, a templates database 809, and an AI engine with a templates module 817 to generate or modify the client-specific templates or the payee-specific templates that have been populated with data.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for template automation and management may be provided. Persons skilled in the art will appreciate that the present invention can be practiced by other than the described embodiments, which are presented for purposes of illustration rather than of limitation.

1. A system comprising:
a processor, and
a management platform comprising:
a management application module configured for clients to manage finances and interact with the management application module using one or more client-specific templates; and
a database comprising the client-specific templates that are populated with client-specific data for the clients;
wherein:
one or more of the client-specific templates comprise one or more fields populated with third-party data obtained from one or more third parties; and
the management application module is configured to:
detect, by the processor using a template automation artificial intelligence (AI) engine that is configured to use machine learning to monitor and implement template changes and is operatively connected to the management application module, a change in the third-party data that has been populated in the one or more fields as first data in a first of the one or more client-specific templates;
determine, by the processor using the template automation AI engine, whether one or more of the one or more client-specific templates other than the first of the one or more client-specific templates includes the first data; and
automatically update, by the processor using the template automation AI engine, the one or more client-specific templates that include the first data in the one or more fields to update the first data to the second data that reflects the change in the third-party data.

2. The system of claim 1, wherein the one or more client-specific templates are customizable by the clients or by an entity that owns or manages the management platform.

3. The system of claim 1, wherein:
the first data and the second data each comprise one or more codes; and
the update of the first data to the second data comprises a code change.

4. The system of claim 3, wherein the one or more codes comprise one or more of an American Bankers Association (ABA) routing number, a business identifier code (BIC), or a tax-related code.

5. The system of claim 3, wherein the first data and the second data comprise contact information for an organization or a payment recipient and the update of the first data comprises a change in the contact information.

6. The system of claim 1, wherein the template automation AI engine is further configured to initiate the detection of the update to the third-party data from the first data to the second data upon the client arranging for an electronic payment to be made.

7. The system of claim 1, wherein the template automation AI engine is further configured to recognize a client failure to pay an amount due to a recipient due to the change in the third-party data populated in the one or more fields in a first of the one or more client-specific templates and to automatically update one or more of the one or more fields of the first data to the second data in the first of the client-specific templates to enable a successful payment of the amount due.

8. The system of claim 1, wherein the template automation AI engine is further configured to prompt a client to confirm that the automated update of the first data to the second data in the one or more of the client-specific templates that include the first data should proceed before the automated change is performed.

9. The system of claim 1, wherein the one or more client-specific templates are populated based on client-provided information.

10. The system of claim 1, wherein the update to the third-party data has been made by the third party externally to the management platform.

11. The system of claim 1, wherein the management application module comprises a banking application for conducting banking.

12. The system of claim 1, wherein:
the database further comprises a plurality of recipient-specific templates configured for use by a recipient to track payments by one or more payors to the recipients, wherein the recipient is an account holder at a financial institution to whom payments are transferred; and
the template automation AI engine, using machine learning, further comprises a recipient template module that is configured to:
take, by the processor, an automated inventory of the plurality of recipient-specific templates for the recipient in the database to automatically identify the recipient-specific templates for the recipient that are included in the database;
analyze, by the processor, the inventoried plurality of recipient-specific templates for template configurations including organization and contents;
automatically merge, by the processor, the plurality of the recipient-specific templates for the payee into a combined recipient-specific template that is populated with payor data from the plurality of recipient-specific templates and is organized for presentation to the recipient based on organization and contents of the recipient-specific templates.

13. The system of claim 12, wherein [each of] the plurality of recipient-specific templates for the recipient comprises payment data for payments received by the recipient per recipient account.

14. The system of claim 12, wherein the template automation AI engine is further configured to monitor and analyze usage of the plurality of recipient-specific templates and the combined recipient-specific template is configured based on the plurality of recipient-specific templates for the recipient.

15. The system of claim 12, wherein the combined recipient-specific template is configured based on one of the plurality of recipient-specific templates or portions thereof that are most used by the recipient at a time at which the combined recipient-specific template for the specific recipient is generated.

16. The system of claim 15, wherein the combined recipient-specific template is configured based on one of the plurality of recipient-specific templates that the template automation AI engine determines for the recipient to review at a time of the merging of the recipient-specific templates of the payee.

17. A system comprising:
a processor;
a management platform for interacting with account holders at a financial institution to whom payments are transferred or owed by one or more parties; comprising:
a database comprising recipient-specific templates that are configured for use by the recipients to track payments by the one or more parties to the recipients, and
a template automation AI engine that is configured to use machine learning to monitor and implement template changes and comprises payee template module that is configured to:
take, by the processor, an automated inventory of the recipient-specific templates for a specific one of the recipients to automatically identify the recipient-specific templates for the recipient that are included in the database;
analyze, by the processor, the inventoried recipient-specific templates for template configurations;
automatically merge, by the processor, the multiple recipient-specific templates for the specific recipient into a combined recipient-specific template that is populated with data from the recipient-specific templates and is organized, based on the template configurations and usage of the recipient-specific templates, for presentation to the specific recipient based on the template configurations.

18. The system of claim 17, wherein the combined recipient-specific template comprises payment data for payments received by the specific recipient that indicates in which respective recipient account the payments were deposited.

19. The system of claim 17, wherein the template automation AI engine is further configured to monitor and analyze usage of the multiple recipient-specific templates for the specific recipient, and the combined recipient-specific template is configured based on the multiple recipient-specific templates for the specific recipient.

20. The system of claim 17, wherein the combined recipient-specific template is further configured to be based on one or more of the multiple recipient-specific templates that the template automation AI engine determines for the specific recipient at a time of the merging of the multiple recipient-specific templates of the specific recipient to analyze payments.
